(19) United States
(12) Patent Application Publication
(10) Pub. No.: US 2007/0141284 A1
(43) Pub. Date: Jun. 21, 2007

(54) Smooth bore flexible fluid conduit

(75) Inventors: George E. Carpenter, Succasunna, NJ (US); Donald C. Bishop, Morristown, NJ (US); Stephen G. Van Pelt, Cranford, NJ (US); Lily Lei, Morristown, NJ (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 11/313,214

(22) Filed: Dec. 19, 2005

(51) Int. Cl. B60R 21/16; B32B 1/08

(52) U.S. Cl. 428/36.1; 428/36.91

(57) ABSTRACT

A fluid conduit including an inner layer is provided. The inner layer includes a polymer and has an interior surface and an exterior surface. The interior surface has an Ra not greater than about 50 microns. The exterior surface is convoluted.

### FIELD OF THE DISCLOSURE

This disclosure, in general, relates to flexible fluid conduits having a smooth bore.

### BACKGROUND

Large-scale production of pharmaceuticals, fluids for use in medical applications, and food grade products relies on maintenance of sanitary environments. Exposure of such products to bacteria or contaminants results in a reduced quality and, in some cases, toxic byproducts. As such, food and medical product manufacturers attempt to reduce points of contamination and limit dead space areas and crevices in which bacteria may congregate and multiply. As such, manufacturers have turned to sanitary hoses and fittings as part of an effort to maintain a sanitary environment.

In part, manufacturers have turned to lined hoses that include non-stick and bacteria resistant polymers. However, typical hoses formed of such non-stick polymers tend to be inelastic, resulting in hoses and fluid conduits having high minimum bend radii and high force-to-bend values. Manufacturers have attempted to use convoluted hoses to maintain permeability and improve force-to-bend values. However, such attempts introduce internal dead spaces that provide space for bacteria growth and difficult to clean. For example, some manufacturers have turned to compression techniques to introduce external convolutions into polymer hoses. However, such techniques alter the roughness of the interior surface of the hose, providing areas for bacterial growth. As such, an improved fluid conduit would be desirable.

### SUMMARY

In a particular embodiment, a fluid conduit includes an inner layer. The inner layer includes a polymer and has an interior surface and an exterior surface. The interior surface has an Ra not greater than about 50 microns. The exterior surface is convoluted.

In another exemplary embodiment, a hose includes a liner having an interior surface and an exterior surface. The internal surface has an Ra of not greater than about 50 microns. The external surface is convoluted.

In a further exemplary embodiment, a fluid conduit includes a liner. The liner includes at least about 80 wt % polytetrafluoroethylene and has an interior surface having an Ra not greater than about 50 microns. The fluid conduit has a force-to-bend of not greater than about 2.0 lbs for a ½-inch inner diameter (ID) configuration, not greater than about 4.0 lbs for a ¾-inch inner diameter (ID) configuration, not greater than about 8.0 lbs for a 1-inch inner diameter (ID) configuration, not greater than about 12.0 lbs for a 1¼-inch inner diameter (ID) configuration, not greater than about 16.0 lbs for a 1½-inch inner diameter (ID) configuration, or not greater than about 24.0 lbs for a 2-inch inner diameter (ID) configuration.

In an additional embodiment, a fluid conduit includes a liner and a braided reinforcement. The liner has an interior surface and an exterior surface. The interior surface defines a lumen for fluid flow therethrough and has an Ra not greater than about 50 microns. The exterior surface is convoluted. The braided reinforcement layer overlies the exterior surface of the liner.

In another exemplary embodiment, a method of hose manufacture includes the step of providing a polymeric tube having an interior surface and an exterior surface. The interior surface has an Ra of not greater than about 50 microns. The exterior surface is generally unconvoluted. The method further includes the step of removing material from the exterior surface to form at least one convolution in the exterior surface.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary fluid conduit.

FIGS. 2, 3, 4, 5, 6, 7 and 8 include illustrations of exemplary convolution profiles for use in a liner of a fluid conduit, such as the exemplary fluid conduit illustrated in FIG. 1.

The use of the same reference symbols in different drawings indicates similar or identical items.

### DETAILED DESCRIPTION OF THE DRAWINGS

In an exemplary embodiment, a fluid conduit includes a liner having an interior surface and an exterior surface. The interior surface, for example, defines a lumen for fluid flow therethrough. In general, the interior surface has an initial roughness (Ra) not greater than 50 microns. The exterior surface of the liner is convoluted and includes one or more annular or helical convolutions. In particular, the liner of the fluid conduit may be formed of a halogenated polyolefin, such as polytetrafluoroethylene (PTFE). In an alternative embodiment, the fluid conduit further includes a reinforcement layer overlying the exterior surface of the liner. The reinforcement layer may be formed of braided metal strands or polymer fibers. In addition, the fluid conduit may include a jacket layer overlying the reinforcement layer; the jacket layer may include an elastomeric polymer.

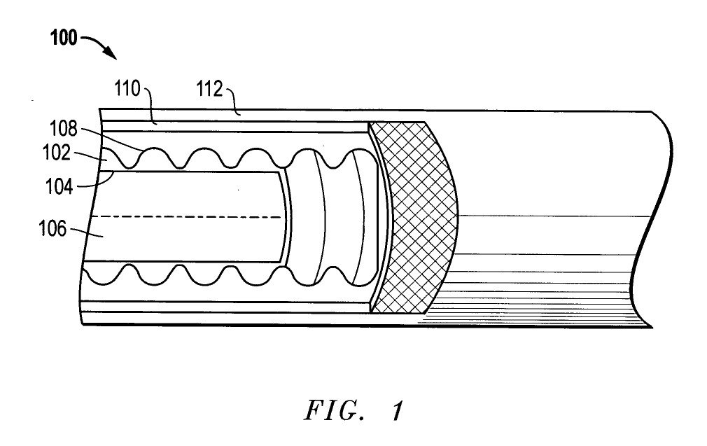

In an exemplary embodiment, FIG. 1 includes an illustration of an exemplary fluid conduit 100. The exemplary fluid conduit 100 includes a liner 102. In addition, the fluid conduit 100 may include a reinforcement layer 110 overlying the liner 102 and, optionally, axially surrounding the liner along its entire length. Further, the fluid conduit 100 may include a jacket layer 112 overlying and, optionally, axially surrounding the liner 102 and the optional reinforcement layer 110. In an example, the liner 102 and reinforcement layer 110 may be coupled together or fastened together at an end of the fluid conduit by a fitting (not shown). In such an example, the liner 102 and the reinforcement layer 110 may be otherwise unattached. In another example, the jacket 112 may be coated over the reinforcement layer 110 or may form a layer that is socked over the reinforcement layer 110 and coupled to the reinforcement layer 110 and liner 102 at an end of the hose by a fitting (not shown).

In an embodiment, the liner 102 is a polymeric tube. An exemplary polymer for use in the liner 102 includes a polyolefin. In an example, the polyolefin includes polyethylene and/or polypropylene. In particular, the polyolefin may include halogenated polyolefin. For example, the halogenated polyolefin may include polyvinyl chloride (PVC), polyvinyl fluoride (PVF), polyvinylidene fluoride (PVDF), polyvinylidene chloride (PVDC), polycholorotrifluoroethylene (PCTFE), polytetrafluoroethylene (PTFE), or blends or copolymers thereof. In a particular embodiment, the liner 102 is formed of a perfluoronated polymer, such as PTFE. In a particular embodiment, a fluoropolymer may be selected from those sold under the Chemfluor® trademark, available from Saint Gobain Performance Plastics Corporation.

In an exemplary embodiment, the liner 102 includes at least about 80 wt % polymer, such as PTFE. For example, the liner 102 may include at least about 85 wt % polymer, such as at least about 90 wt % polymer or at least about 95 wt % polymer. In a particular embodiment, the liner 102 is PTFE in a major part, and can be essentially PTFE.

Particular embodiments of the liner 102 may include additives, such as inorganic fillers, compatibilizers, plasticizers, anti-oxidants, UV absorbers, pigments or colorants. Alternatively, particular embodiments of the liner 102 may be free of such additives and, in particular, may be free of inorganic fillers.

The liner 102 has an interior surface 104 and an exterior surface 108. The interior surface 104 defines a lumen 106 that can accommodate fluid flow therethrough. In general, the lumen 106 extends axially along the hose and through fittings at either end of the fluid conduit (not shown), if so equipped.

In an exemplary embodiment, the interior surface 104 of the liner 102 is smooth, characterized by a low roughness. For example, the liner 102 includes an interior surface 104 having an average roughness (Ra) not greater than about 50 microns. In an example, the Ra of the interior surface 104 is not greater than about 35 microns, such as not greater than about 20 microns or not greater than about 15 microns. In addition to average roughness (Ra) values, the fluid conduit and specifically the interior surface 104 of the liner 102 may have a total roughness (Rt) not greater than about 5.0 microns and a roughness (Rz) not greater than about 2.0 microns. The total roughness (Rt) is generally the vertical distance from the deepest valley to the highest peak and the maximum roughness (Rz) is generally the sum of the height of the highest peak plus the lowest valley depth within a sampling length. Post-flex roughness values indicate the roughness of the interior surface 104 of the liner 102 after the liner 102 undergoes multiple cycles of flexing. A flex cycle includes bending a test strip 180° forward and 180° backward. The liner 102 may have an interior surface 104 having a post-flex (one hundred cycles) Ra not greater than about 60 microns, such as not greater the about 50 microns or not greater than about 45 microns.

The liner 102 includes an exterior surface 108 that is generally convoluted. The convoluted exterior surface defines one or more convolutions. In an example, the one or more convolutions are helical convolutions extending both radially around the center axis of the house or fluid conduit and longitudinally along the axis. In another example, the one or more convolutions are annular convolutions extending latitudinal or radially around the axis, each of the one or more annular convolutions located at a single point longitudinally along the axis.

Such convolutions may define a series of peaks and valleys along the exterior surface 108 of the liner 102. As a result, the liner 102 has a minimum wall thickness at the valleys of the convolutions and a maximum wall thickness at the peaks of the convolutions. In an exemplary embodiment, the liner 102 has a minimum wall thickness of about 10 mils to about 60 mils, such as a minimum wall thickness in a range of about 30 mils to about 60 mils or in a range of about 34 mils to about 40 mils. The liner 102 may also have a maximum wall thickness of about 100 mils to about 160 mils, such as about 105 mils to about 145 mils.

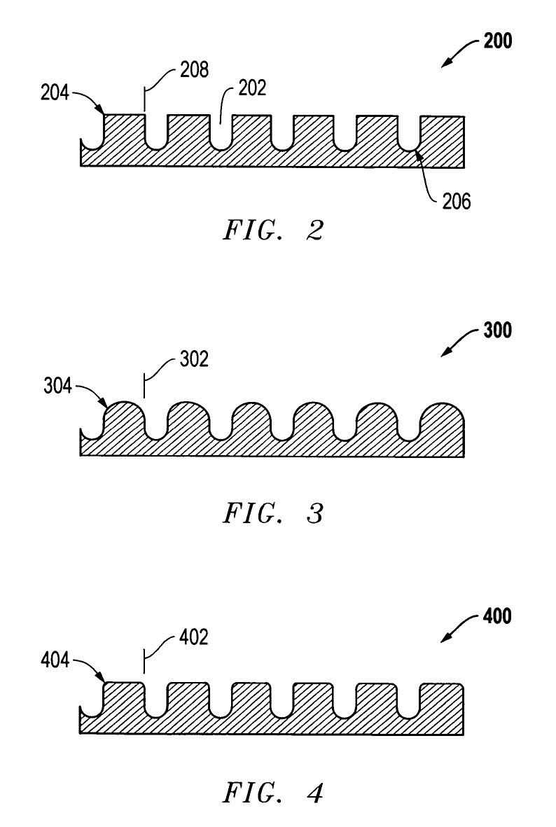

The shape of the convolutions of the exterior surface 108 may influence hose performance in areas of flexibility and minimum radius. FIGS. 2, 3, 4, 5, 6, 7, and 8 include illustrations of exemplary convolution profiles. Such exemplary convolution profiles may be implemented as helical or annular convolutions. For example, FIG. 2 includes a convolution profile 200 having a series of flat-topped peaks 204 separated by valleys 202. As illustrated, the valleys 202 have a bottom 206 characterized by a radius of curvature. In an exemplary embodiment, the radius of curvature of the bottoms 206 of the valleys 202 may be about 25 mils to 40 about mils, such as about 28 mils to about 32 mils.

As illustrated in more detail below, the convolutions may be further characterized in a tangential angle associated with the walls of the valleys 202. The tangential angle is defined as an angle of a tangent line extending along the wall of the valley 202 relative to a normal line extending radially from the axis of the hose. As illustrated in FIG. 2, the tangential angle is about 0°. In alternative embodiments, the tangential angle may be about 0° to about 30°, such as about 17° to about 27°.

The convolutions may be further characterized by the shape of the peaks 204. For example, the peak 204 illustrated in FIG. 2 is substantially flat. In contrast, the peak 304 of the convolutions 300 illustrated in FIG. 3 is rounded, such as forming a semi-circle. In an alternative embodiment, the convolutions 400 illustrated in FIG. 4 include rounded edges 404 of a flat peak. The convolutions illustrated in FIGS. 3 and 4 also include valleys having about 0° tangential angles 302 and 402, respectively.

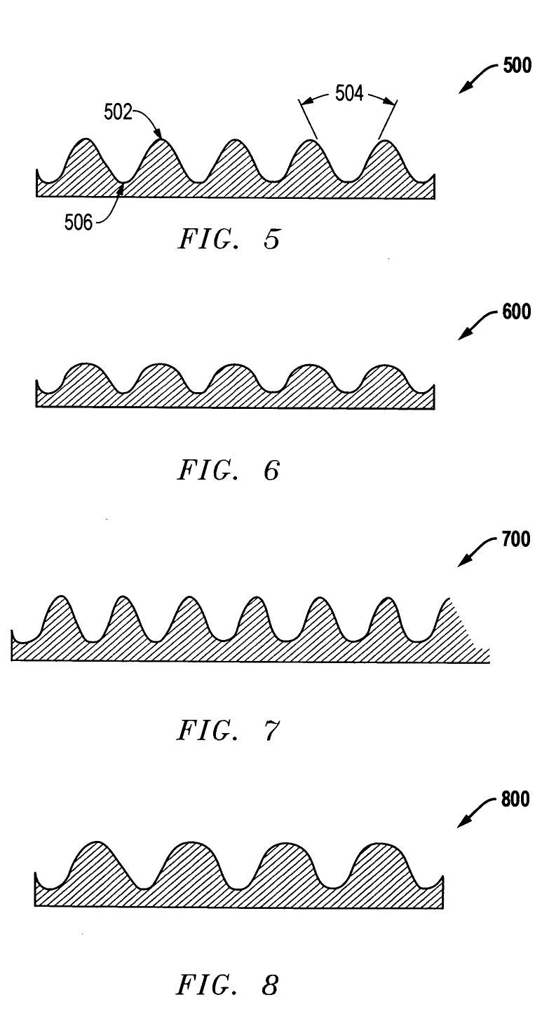

In further examples, FIGS. 5, 6, 7 and 8 include embodiments in which the convolutions have tangential angles greater than about 0°. For example, FIG. 5 includes a set of convolutions 500 having valleys 506 defined by a bottom radius of curvature of about 31 microns, and peaks 502 having a radius of curvature of about 32 microns. Each tangential angle 504 of the convolutions 500 is about 25°.

In contrast, FIG. 6 includes a set of convolutions 600 having larger peak radiuses of curvature. In a further example, FIG. 7 includes a convolution profile in which the radius of curvature at the peak is less than the radius of curvature in the valley. In addition, the convolutions 700 of FIG. 7 are higher or thicker than the convolutions 600 of FIG. 6. In another exemplary embodiment, FIG. 8 includes an exemplary illustration of convolutions 800 including large distances between peaks.

Returning to FIG. 1, the fluid conduit 100 may include a reinforcement layer 110 overlying the exterior surface 108 of the liner 102. The reinforcement layer 110 may be formed of fibers, strands or the like. In particular, the fibers or strands may be braided in a generally tubular sheath, forming a braided material. In an exemplary embodiment, the strands are metallic, such as stainless steel strands. In another exemplary embodiment, the fibers are polymeric fibers formed of a polymer, such as an aramid, a polyimide, a nylon, or a polyolefin. In a particular embodiment, the fibers are formed of an aramid, such as a meta-aramid or a para-aramid. In another exemplary embodiment, the fibers are formed of a polypropylene. The fibers or strands may be woven such that the weave forms an angle relative to the axis of the fluid conduit. In an exemplary embodiment, the angle is between about 0° and about 70°, such as about 30° to about 60°.

In a further exemplary embodiment, the fluid conduit 100 includes a jacket layer 112 overlying the exterior surface 108 of the liner 102 and optionally the optional reinforcement layer 110. The jacket layer 112 may be formed of an elastomeric polymer, such as ethylene propylene diene monomer (EPDM) or silicone. The elastomeric polymer of the jacket 112 may further include compatibilizers, plasticizers, pigments, colorants, UV absorbers, antioxidants, and combinations thereof.

The properties of the fluid conduit are, at least in part, influenced by the dimensions of the fluid conduit, such as, for example, the inner diameter (ID). In general, the fluid conduit may be formed to have an inner diameter (ID), such as ½ inches, ¾ inches, 1 inch, 1¼ inches, 1½ inches, 2 inches or more. Inner diameter (ID) is intended to mean the nominal inner diameter and may vary by +/−50 mils. Such inner diameters are provided for illustrative purposes and fluid conduits may be formed which have different sizes. Performance parameters of the fluid conduit, such as burst pressure, maximum working pressure, minimum bend radius, force-to-bend, and weight per foot, may be influenced by the selection of a particular sized fluid conduit in addition to the construction and methods of manufacturing.

An exemplary embodiment of the fluid conduit described above may have a burst pressure of at least about 2,000 psi, such as at least about 4,000 psi or at least about 4,100 psi for a fluid conduit having an inner diameter (ID) of about ½ inches. In another example, a 1-inch ID fluid conduit may have a burst pressure of at least about 1,500 psi, such as at least about 3,000 psi or at least about 3,150 psi. In other examples, a ¾-inch ID fluid conduit may have a burst pressure at least about 1,800 psi, such as at least about 3,600 psi; a 1¼-inch ID fluid conduit may have a burst pressure at least about 1,350 psi, such as at least about 2,700 psi; a 1½-inch ID fluid conduit may have a burst pressure at least about 1,200 psi, such as at least about 2,400 psi; and a 2-inch ID fluid conduit may have a burst pressure at least about 900 psi, such as at least about 1,800 psi.

The fluid conduit may also exhibit an improved minimum bend radius. The minimum bend radius is defined as half the distance between the inside edge of a hose bent in half so that further bending would result in damage or kinking to the hose. For example, a ½-inch ID fluid conduit may have a minimum bend radius not greater than about 2.0 inches, such as not greater than about 1.8 inches. In another example, a 1-inch ID fluid conduit may have a minimum bend radius not greater than about 4 inches, such as not greater than about 3.8 inches, not greater than about 3.0 inches, or not greater than 2.25 inches. In other examples, a ¾-inch ID fluid conduit may have a minimum bend radius not greater than about 3 inches, a 1¼-inch ID fluid conduit may have a minimum bend radius not greater than about 5 inches, a 1½-inch ID fluid conduit may have a minimum bend radius not greater than about 7 inches, and a 2-inch ID fluid conduit may have a minimum bend radius not greater than about 12 inches.

The fluid conduit may also exhibit an improved force-to-bend property. Force-to-bend is determined using a length of tube equal to six times the minimum bend radius. A length of the hose or fluid conduit equal to two times the minimum bend radius is secured so that four times the minimum bend radius is free. The free end is bent perpendicular to the secured end without exceeding the minimum bend radius. A scale is coupled to the free end parallel to the axis of the secured end to measure the bending force. For example, a ½-inch inner diameter (ID) fluid conduit may have a force-to-bend not greater than about 2 lbs, such as not greater than about 1.0 lbs or not greater than about 0.5 lbs. In another example, a 1-inch ID fluid conduit has a force-to-bend not greater than about 8 lbs., such as not greater than about 4.0 lbs or not greater than about 1.8 lbs. In other examples, a ¾-inch ID fluid conduit has a force-to-bend not greater than about 4.0 lbs, such as not greater than about 1.0 lbs.; a 1¼-inch ID fluid conduit has a force-to-bend not greater than about 12 lbs, such as not greater than about 3 lbs; a 1½-inch ID fluid conduit has a force-to-bend not greater than about 16 lbs, such as not greater than about 4 lbs; and a 2-inch ID fluid conduit has a force-to-bend not greater than about 24 lbs, such as not greater than about 6 lbs.

The fluid conduit may also have improved weight. For example, a ½-inch ID fluid conduit may have a weight not greater than about 0.26 lbs/ft, such as not greater than about 0.24 lbs/ft. In another example, a 1-inch ID fluid conduit may have a weight not greater than about 0.62 lbs/ft, such as not greater than about 0.58 lbs/ft. In other examples, a ¾-inch ID fluid conduit may have a weight not greater than about 0.37 lbs/ft, a 1¼-inch ID fluid conduit may have a weight not greater than about 0.77 lbs/ft, a 1½-inch ID fluid conduit may have a weight not greater than about 1.04 lbs/ft, and a 2-inch ID fluid conduit may have a weight not greater than about 1.72 lbs/ft.

Another aspect of the present invention is directed to a method of hose manufacture. In a particular embodiment, the hose may be formed by removing material from the exterior surface of a smooth bore polymeric tube. For example, a smooth bore polymeric tube having an interior surface having roughness Ra not greater than about 50 microns may be provided. At least one convolution is formed into the exterior surface of the polymeric tube by removing material to form a hose liner having a convoluted exterior surface. In an example, removing material includes grinding material or shaving material. In a particular example, the material is removed below the glass transition temperature of the polymeric tube. In other embodiments, the material is removed at or near room temperature.

The method may further include overlaying a reinforcement layer over the hose liner. For example, a reinforcement layer including a braided or woven material or tube formed of metal strands or polymeric fibers may be sheathed or socked over the hose liner. A jacket may be applied overlying the hose liner and optionally overlying the reinforcement layer. For example, the jacket material may be formed of an elastomer coated over the reinforcement layer. In another example, the jacket may be an elastomeric polymer tube socked over the reinforcement layer and the hose liner. In a particular embodiment, the jacket forms an outer most surface of the fluid conduit.

### EXAMPLE 1

A fluid conduit having an inner liner as described above is compared with a hose having an inner liner formed through a compression method. The respective liners are cut along the length of the liner. The strips are then measured for roughness before flexing, after ten flex cycles, after fifty flex cycles and after one hundred flex cycles. A flex cycle includes bending a test strip 180 degrees forward and 180 degrees backward.

Roughness measurements are made using a rank profilometer, having a probe that is dragged along the length of the liner inner diameter. Average roughness (Ra) values are illustrated in the table below. In addition, the table includes total roughness (Rt) and maximum roughness (Rz) values.

TABLE 1
Initial Surface Roughness

| | Number of | Ra | Rt | Rz DIN |
|---|---|---|---|---|
| Sample No. | Bends | (microns) | (microns) | (microns) |
| Sample - 1 | 0 | 0.1279 | 3.5644 | 0.7442 |
| | 10 | 0.2432 | 4.1789 | 0.9846 |
| | 50 | 0.4002 | 4.7869 | 1.2179 |
| | 100 | 0.4281 | 4.6612 | 1.0524 |
| Sample - 2 | 0 | 0.1197 | 2.0166 | 0.6722 |
| | 10 | 0.2801 | 5.0138 | 0.9644 |
| Sample -3 | 0 | 0.1412 | 2.7694 | 0.7466 |
| | 50 | 0.2232 | 3.3002 | 0.9255 |
| | 100 | 0.2212 | 2.1259 | 0.8794 |
| A - Flex - 1 | 0 | 0.5640 | 7.2031 | 2.3059 |
| | 10 | 0.6498 | 6.3777 | 2.4910 |
| | 50 | 0.6933 | 6.3062 | 2.5403 |
| | 100 | 0.7075 | 7.2463 | 2.7511 |
| A - Flex - 2 | 0 | 0.6348 | 5.4496 | 2.3753 |
| | 10 | 0.6533 | 5.9212 | 2.5076 |
| | 50 | 0.7105 | 3.4865 | 2.6200 |
| | 100 | 0.6917 | 5.6751 | 2.6410 |

When compared to two commercially available hose products including press formed convolutions in an inner liner, the samples including the liner formed as described herein have reduced Ra, Rt and Rz. For example, the present hose has an initial Ra value not greater than approximately 0.14 microns, while the comparative products have initial Ra values of 0.56 and 0.63 microns, respectively. After flexing, such as flexing through one hundred cycles, the present hose samples have an increased roughness Ra value that is still significantly below the Ra value of the comparative hose products. For example, the Ra value of an embodiment of the present fluid conduit after undergoing one hundred flex cycles is not greater than approximately 0.42 microns, contrasted with the 0.70 micros and 0.69 microns of the comparable examples.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A fluid conduit comprising an inner layer, the inner layer comprising a polymer and having an interior surface and an exterior surface, the interior surface having an Ra not greater than about 50 microns, the exterior surface being convoluted.

2. The fluid conduit of claim 1, wherein the interior surface defines a lumen for fluid flow therethrough.

3. The fluid conduit of claim 1, further comprising a reinforcement layer overlying the exterior surface of the inner layer.

4-5. (canceled)

6. The fluid conduit of claim 3, wherein the reinforcement layer includes braided material.

7. The fluid conduit of claim 3, further comprising a jacket layer overlying the reinforcement layer.

8. The fluid conduit of claim 7, wherein the jacket layer comprises elastomeric polymer.

9. The fluid conduit of claim 1, wherein the inner layer comprises halogenated polyolefin.

10. The fluid conduit of claim 9, wherein the halogenated polyolefin comprises polytetrafluoroethylene (PTFE).

11-13. (canceled)

14. The fluid conduit of claim 1, wherein the Ra is not greater than about 35 microns.

15-16. (canceled)

17. The fluid conduit of claim 1, wherein the interior surface has a post-flex Ra not greater than about 60 microns.

18-20. (canceled)

21. The fluid conduit of claim 1, wherein the fluid conduit has a minimum bend radius not greater than about 2 inches for a ½-inch inner diameter (ID) configuration.

22. (canceled)

23. The fluid conduit of claim 1, wherein the fluid conduit has a force-to-bend not greater than about 2.0 lbs for a ½-inch inner diameter (ID) configuration.

24-28. (canceled)

29. The fluid conduit of claim 1, wherein the inner layer has a minimum wall thickness of about 10 mils to about 60 mils.

30. (canceled)

31. The fluid conduit of claim 1, wherein the inner layer has maximum wall thickness of about 100 mils to about 160 mils.

32-44. (canceled)

45. The fluid conduit of claim 1, wherein the exterior surface includes a helical convolution.

46. The fluid conduit of claim 1, wherein the exterior surface includes an annular convolution.

47. The fluid conduit of claim 1, wherein convoluted exterior surface defines a tangential angle of about 0° to about 30°.

48. (canceled)

49. A hose comprising a liner having an interior surface and an exterior surface, the internal surface having an Ra of not greater than about 50 microns, the external surface being convoluted.

50. The hose of claim 49, wherein the Ra is not greater than about 35 microns.

51. (canceled)

52. The hose of claim 49, further comprising a reinforcement layer overlying the exterior surface of the liner.

53. The hose of claim 52, further comprising a jacket layer overlying the reinforcement layer.

54-72. (canceled)

73. A method of hose manufacture, the method comprising the steps of:
providing a polymeric tube having an interior surface and an exterior surface, the interior surface having an Ra of not greater than about 50 microns, the exterior surface being generally unconvoluted; and
removing material from the exterior surface to form at least one convolution in the exterior surface.

74. The method of claim 73, further comprising sheathing the convoluted polymeric tube with a braided sheath.

75-76. (canceled)

77. The method of claim 73, further comprising applying a jacket overlying the convoluted polymeric tube.

78-79. (canceled)

80. The method of claim 77, wherein removing material includes grinding material from the external surface.

81. The method of claim 77, wherein removing material includes shaving material.
